(19) United States
(12) Patent Application Publication
(10) Pub. No.: US 2015/0169571 A1
(43) Pub. Date: Jun. 18, 2015

(54) Social Image Search

(71) Applicants: Julia H. Farago, Somerville, MA (US); Terran Melconian, Revere, MA (US); Ankur Bhargava, Cambridge, MA (US); David Bau, Lincoln, MA (US); Manish M. Sambhu, San Francisco, CA (US); Francisco M. Galanes, Wellesley, MA (US)

(72) Inventors: Julia H. Farago, Somerville, MA (US); Terran Melconian, Revere, MA (US); Ankur Bhargava, Cambridge, MA (US); David Bau, Lincoln, MA (US); Manish M. Sambhu, San Francisco, CA (US); Francisco M. Galanes, Wellesley, MA (US)

(73) Assignee: Google Inc., Mountain View, CA (US)

(21) Appl. No.: 12/909,814

(22) Filed: Oct. 21, 2010

Related U.S. Application Data
(60) Provisional application No. 61/253,832, filed on Oct. 21, 2009.

(51) Int. Cl. G06F 17/30

(52) U.S. Cl. CPC G06F 17/3053; G06F 17/30867; G06F 17/30554

(57) ABSTRACT

Methods, systems, and apparatus, including computer programs encoded on a computer storage medium, for identifying and providing image search results including general image search results responsive to an image search query and social image search results responsive to the image search query wherein each of the social image search results is associated with content generated by a respective member of a social graph of a user wherein the member is at two or more distinct degrees of separation from the user and has a minimum number of social graph friends in common with the user.

### CROSS-REFERENCE TO RELATED APPLICATIONS

This application claims the benefit under 35 U.S.C. §119(e) of U.S. Provisional Patent Application Ser. No. 61/253,832 filed on Oct. 21, 2009, which is incorporated by reference in its entirety.

### BACKGROUND

The present disclosure relates to image searching.

Search engines aim to identify resources (e.g., images, audio, video, web pages, text, documents) that are relevant to a user's needs and to present information about the resources in a manner that is most useful to the user. Search engines return a set of search results in response to a user submitted text query. For example, in response to an image search text query (i.e., a query to identify image resources), the search engine returns a set of search results identifying image resources responsive to the query (e.g., as a group of thumbnail representations of the image resources).

A large number of image search results can be presented to a user, e.g., in response to an image search query. However, a user may be interested in images associated with a particular social graph (e.g., friends of the user). Conventionally, these images may be unavailable or difficult to find among other returned image search results.

### SUMMARY

This specification describes technologies relating to image searching.

A user's social graph includes a collection of connections (e.g., users or resources) identified as having a relationship to the user within a specified degree of separation. The user's social graph can be used to identify search results responsive to a query that are associated with one or more members of the user's social graph.

In general, one aspect of the subject matter described in this specification can be embodied in methods that include the actions of receiving an image search query from a user, the image search query including one or more terms for identifying image resources responsive to the query; identifying image search results including general image search results responsive to the search query and social image search results associated with content generated by one or more members of the user's social graph at two or more distinct degrees of separation from the user and that are responsive to the image search query; and presenting a plurality of the identified image search results to the user including presenting one or more image social search results. Other embodiments of this aspect include corresponding systems, apparatus, and computer program products.

These and other embodiments can optionally include one or more of the following features. Presenting one or more of the identified image search results includes presenting the one or more image search results associated with the user's social graph interleaved with one or more general image search results. Presenting one or more of the identified image search results includes separately presenting image search results associated with the user's social graph from general identified search results. Presenting one or more of the identified image search results includes: presenting both general image search results and social image search results; receiving user input to filter the presented image search results; and filtering the image search results to remove the general image search results. Filtering the image search results includes removing all image search results other than the image search results associated with a selected member of the user's social graph. Filtering the image search results includes removing all image search results other than the image search results associated with a selected image source. The member's of the user's social graph are determined based on connections to the user according to a degree of separation. Identifying one or more image search results associated with the user's social graph includes searching an index of information associated with the user's social graph.

Particular embodiments of the invention can be implemented to realize one or more of the following advantages. Search results can be refined using a user's social graph in order to improve the user's search experience and to make content associated with the user's social graph more visible and accessible to the user.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 is a diagram of example sources of social graph information.

FIG. 2 is a flow diagram of an example method for using social graph information.

FIG. 3 is a flow diagram of an example method for presenting search results including social graph information.

FIG. 4 is a representation of an example image search results page including image results associated with the user's social graph.

FIG. 5 is a representation of an example image search results page showing image results associated with the user's social graph.

FIG. 6 is a representation of an example image search results page showing image results associated with the user's social graph.

FIG. 7 is a representation of an example image search results page showing image results associated with a selected member of a user's social graph.

FIG. 8 is a representation of an example display when a user selects a particular search result.

FIG. 9 is a representation of an example image search results page showing image results associated with friends including a search friend filter.

FIG. 10 is a representation of an example image search results page showing image results associated with friends including a browse friend filter.

FIG. 11 is a representation of an example image search results page showing image results associated with friends including source filtering.

FIG. 12 is a representation of an example image search interface including image results associated with the user's social graph.

FIG. 13 is a representation of an example null image search results page including images results associated with the user's social graph.

FIG. 14 is a representation of an example image search interface including image results associated with the user's social graph.

Like reference numbers and designations in the various drawings indicate like elements.

### DETAILED DESCRIPTION

As used in this specification, a social graph can refer to a single social graph or multiple interconnected social graphs. Distinct social graphs can be generated for different types of connections a user has. For example, a user can be connected with chat contacts in one social graph, email contacts in a second social graph, and a connections from a particular social network in a third social graph. Each social graph can include edges to additional individuals or entities at higher degrees of separation from the user. For example, an email contact can have its own email contacts to others adding a degree of separation from the user (e.g., user→email contact→contact of email contact). These contacts can in turn have additional contacts at another degree of separation from the user. Similarly, a user's connection to someone in a particular social network can then be used to identify additional connections based on that person's connections. The distinct social graphs can include edges connecting one or more social graph to one or more other social graphs.

Types of connections and social graphs can include, but are not limited to other users in which the user is in direct contact (e.g., user mail or chat contact, direct contacts on social sites) and users in which the user is in indirect contact (e.g., friends of friends, connections of users that have a direct connection to the user). In some implementations, the social graph includes content generated by individuals (e.g., blog posts, reviews) as connections to the user. The social graph can include connections within a single network or across multiple networks (separable or integrated).

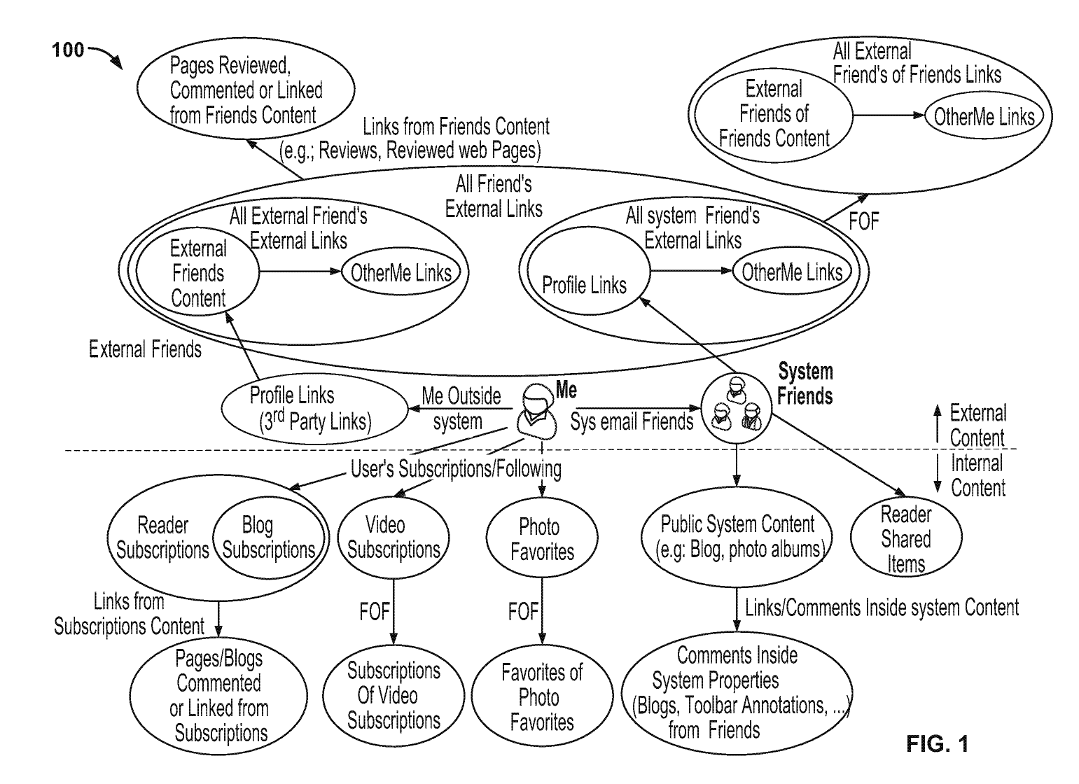

FIG. 1 is a diagram 100 of example sources of social graph information. The user's social graph is a collection of connections (e.g., users, resources) identified as having a relationship to the user within a specified degree of separation. The user's social graph can include people and particular content at different degrees of separation. For example, the social graph of a user can include friends, friends of friends (e.g., as defined by a user, social graphing site, or other metric), the user's social circle, people followed by the user (e.g., subscribed blogs, feeds, or web sites), co-workers, and other specifically identified content of interest to the user (e.g., particular web sites).

Diagram 100 shows a user and the different connections possible to extend a user's social graph to people and content both within a system and across one or more external networks and shown at different degrees of separation. For example, a user can have a profile or contacts list that includes a set of identified friends, a set of links to external resources (e.g., web pages), and subscriptions to content of the system (e.g., a system that provides various content and applications including e-mail, chat, video, photo albums, feeds, or blogs). Each of these groups can be connected to other users or resources at another degree of separation from the user. For example, the friends of the user each have their own profile that includes links to resources as well as friends of the respective friends. The connections to a user within a specified number of degrees of separation can be considered the social graph of the user. In some implementations, the number of degrees of separation used in determining the user's social graph are user set. Alternatively, a default number of degrees of separation is used. Moreover, a dynamic number of degrees of separation can be used that is based on, for example, the type of connection.

In some implementations, the membership and degree of separation in the social graph is based on other factors, including a frequency of interaction. For example, a frequency of interaction by the user (e.g., how often the user visits a particular social graphing site) or type of interaction (e.g., endorsing or selecting items associated with friends). As interaction changes, the relationship of a particular contact in the social graph can also dynamically change. Thus, the social graph can be dynamic rather than static.

In some alternative implementations, social signals can be layered over the social graph (e.g., using weighted edges or other weights between connections in the social graph). These signals, for example, frequency of interaction or type of interaction between the user and a particular connection, can then be used to weight particular connections in the social graph or social graphs without modifying the actual social graph connections. These weights can change as the interaction with the user changes.

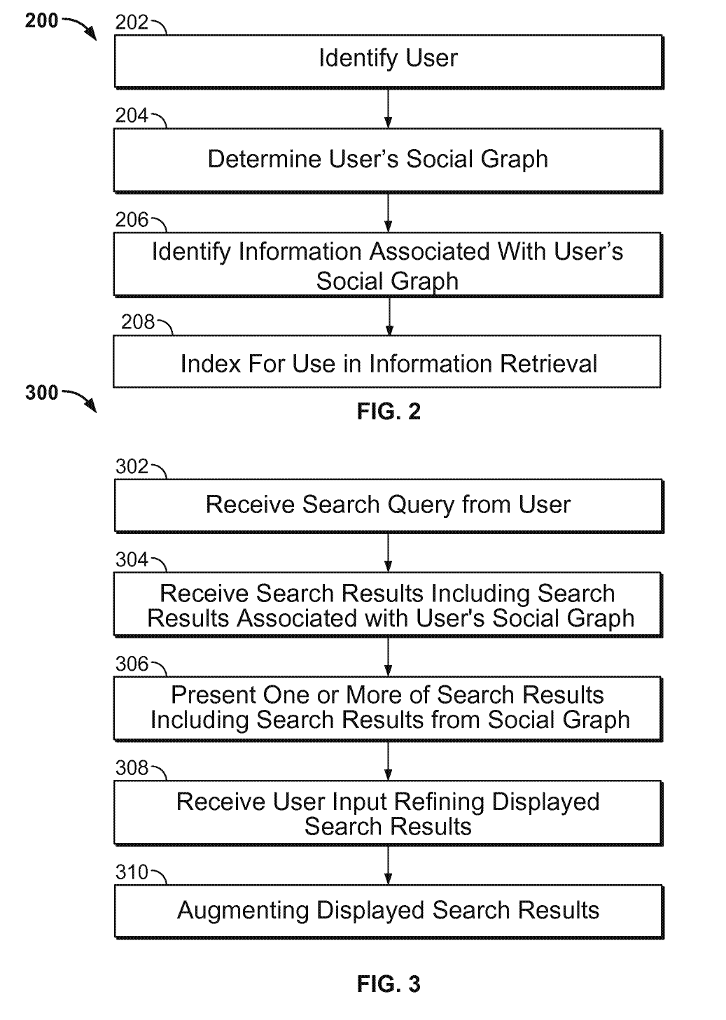

FIG. 2 is a flow diagram of an example method 200 for using social graph information. For convenience, the method 200 will be described with respect to a system, including one or more computing devices, that performs the method 200.

The system identifies 202 a user. The user can be identified, for example, based on a user profile associated with the system. The user profile can be identified, for example, with a username, email address, or other identifier.

The system determines 204 the user's social graph. The user's social graph identifies people and resources associated with the user, for example, in which the user has indicated an interest. In some implementations, the social graph is limited to a specified number of degrees of separation from the user or particular relationships or types of interaction with the user. In some alternative implementations, the user's social graph is generated by another system and provided upon request.

In some implementations, the user's social graph is determined using user profile data, as well as extracting information from users and resources identified in the user profile data. For example, the user's profile can include a list of the user's friends. The user's friends can include friends within the system (e.g., using a same e-mail or chat service that is affiliated with the system) or external to the system (e.g., social graphs or a list of contacts associated with third party applications or service providers). The user's profile can also include a list of subscriptions to which the user belongs (e.g., identifying content that the user follows, for example, particular blogs or feeds).

The user's profile can also include external links identified by the user. These links can identify particular content of interest. In some implementations, the user's profile also identifies other aliases used by the user (e.g., as associated with particular content providers or social graph sources). For example, a user may have a first identity for a chat application and a second identity for a restaurant review web site. These two identities can be linked together in order to unify the content associated with that user.

The social graph can be further expanded by extracting information from the identified people and content in the user's profile. For example, public profile information can exist for identified friends from which information can be extracted (e.g., their friends, links, and subscriptions). In some implementations, the user can adjust the members of the social graph directly. For example, the user can group their contacts (e.g., e-mail contacts) into particular groups accessed by the system in building the user's social graph.

Similarly, a user can prevent the system from adding members to the user's social graph, for example, by an opt-out option or by keeping contacts out of the particular groups used by the system to generate the social graph. In some other implementations, privacy features provide a user with an opt-in or opt-out option to allow or prevent, respectively, being included (or remove the user if already included) as a member of another's social graph. Thus, users can have control over what personal information or connection information, if any, is included in social graphs.

The system identifies 206 information associated with the user's social graph. Identified content associated with the user's social graph can include, for example, content or posting to resources subscribed to by the user (e.g., particular blogs). The identified information can also include content generated by members of the user's social graph. For example, members of a user's social graph can generate content including, for example, local reviews (e.g., for restaurants or services), video reviews and ratings, product reviews, book reviews, blog comments, news comments, maps, public web annotations, public documents, streaming updates, photos and photo albums. Thus, the content can include both content generated by the members of the user's social graph, as well as content endorsed or reviewed by the members of the user's social graph.

The system indexes 208 identified social graph information for use in information retrieval. For example, the index can be searched in response to a received search query to identify relevant search results associated with members of the user's social graph. For example, a search system can receive a query and identify both general search results as well as search results based on the indexed social graph information. In some implementations, the indexed social graph information is periodically updated, for example, to include recently added information associated with the user's social graph.

FIG. 3 is a flow diagram of an example method 300 for presenting search results including social graph information. For convenience, the method 300 will be described with respect to a system including one or more computing devices that performs the method 300.

The system receives 302 a search query from a user. For example, the user can input a search query into a search interface of a particular search system. The search query includes one or more terms and can be general or directed to particular types of resources (e.g., a web search or an image search).

The user can submit the search query from a client device. The client can be a computer coupled to the search system through a local area network (LAN) or wide area network (WAN), e.g., the Internet. In some implementations, the search system and the client device is a single machine. For example, a user can install a desktop search application on the client device. The user can submit the search query to a search engine within the search system.

When the user submits the search query, the search query is transmitted through a network to the search system. The search system can be implemented as, for example, computer programs running on one or more computers in one or more locations that are coupled to each other through a network.

The system receives 304 search results including search results associated with the user's social graph. For example, when the search query is received by a search engine, the search engine identifies resources that are responsive to the search query using an index. The search engine will generally include an indexing engine that indexes resources (e.g., web pages, images, or news articles on the Internet) found in a corpus (e.g., a collection or repository of content), an index database that stores the index information, and a ranking engine (or other software) to rank the resources that match the query. The indexing and ranking of the resources can be performed using conventional techniques. The social graph information can in be included in a same index as other resources or a separate index. Consequently, a separate search can be performed for general search results responsive to the query, as well as particular search results that identify resources associated with the user's social graph.

In some implementations, the presentation and ranking of search results associated with the user's social graph is adjusted by one or more factors including one or more social signals. For example, affinity can be used to determine whether to show content from a particular member of the user's social graph or whether to promote or demote the member's ranking. Affinity identifies the closeness of a member to the user. For example, a friend of a friend who has five common middle friends with the user has a higher affinity than a friend of a friend who has only one common middle friend. Other factors in determining affinity can include: how a friend is connected to the user (e.g., the source of the connection), which social graphing site the friend is a member of, whether friend or friend of friend, and how many paths to get to the friend of a friend (e.g., common middle friends).

Affinity can also be based on the user's interactions with members of the social graph (e.g., frequency, type). For example, a user that frequently clicks on posts by a particular contact can have a higher affinity with that contact than the affinity with other contacts where they click on respective posts less frequently. Affinity can also be greater for particular types of interactions, for example, comments on contact's posts can result in higher affinity than occasional endorsements. Affinity can change over time. For example, as the types or frequency of interactions change with members of the social graph, the resulting affinity can change as well.

Ranking can also be effected based on other factors, for example, an information retrieval score of social graph content relative to the submitted query (e.g., relevance of the social graph content), content type (e.g., blogs versus images), and the date of the associated content.

Additionally, when interleaving search results associated with the user's social graph along with general search results, a promotion can be applied to the search results associated with the user's social graph in order to increase their visibility. For example, the ranking of search results associated with the user's friends is often lower than a general wide-spread result. Thus, promotion of search results associated with the user's social graph can prevent them from being buried by general search results.

In some implementations, users indicate particular resources as endorsed (e.g., staring a search result or providing an indication at the resource), share resources, quote URLs or otherwise indicate and interest or liking of content, for example, a particular resource, web page, or search result. For example, an application, widget, or scripting can be provided in search results pages, web pages, or within a browser application that allows a user to indicate liking, sharing, or other evaluation of the associated resource or search result. For example, the user can mark a particular resource, web site, or search results to indicate endorsement or other evaluation (e.g., though a browser control or user interface element presented with the associated content).

These interactions performed by members of the user's social graph can be used as social signals to adjust rankings of corresponding search results. For example, if a search query identifies results that include a resource that has been so identified by a member of the user's social graph, this result can be boosted relative to other general search results responsive to the user's query. The boosting factor could be based on, for example, the number of friends who endorsed the identified resource or a top affinity to a friend who endorsed the identified resource. Boosting can also be based on authorship (e.g., what is the relationship or affinity with the individual that endorsed the resource), or the type of endorsement did the member of the user's social graph provide (e.g., an explicit endorsement by starring a result or page or an implicit endorsement by visiting the resource or commenting on a posting).

The system presents 306 one or more of search results including search results from social graph. The search engine can transmit the search results through the network to the client device for presentation to the user e.g., as a search results web page to be displayed in a web browser running on the client device. In some implementations, the system clusters search results from the social graph by member of the social graph and presents the responsive results for that member together.

For example, the received search query can be an image query “sunset”. The system receives image search results responsive to the query “sunset”. This can include search results identifying various images representing a sunset or otherwise tagged as associated with a sunset. The image search results can also include image search results associated with the user social graph, for example, photos from various friends of sunsets. The image search results can be presented to the user, e.g., as a search results page, that includes one or more of the general search results and the search results associated with the user's social graph.

The search results can be presented in a number of different ways. The search results can be presented to the user, e.g., as a search results page, that includes one or more of the general search results and the search results associated with the user's social graph. The search results can be presented with separate portions displaying general search results and social graph results, respectively. Alternatively, relevant search results associated with the user's social graph can be interleaved with general search results. Additionally, the results whether displayed separately or interleaved, can be separated by type of content (e.g., web page listings, images).

The search results associated with the user's social graph can also be displayed in according to content type (e.g., an image or web page) or clustered according to social graph member. In some implementations, when clustering the results from the social graph by member of the social graph, the content from each member having responsive content will be grouped together for presentation (e.g., the photos and review of friend one followed by the photos of friend two).

The system receives 308 user input refining displayed search results. For example, the user can filter the presented search results according to various criteria. The criteria can include, for example, filtering according to a particular friend or source of the resource identified by the search results. Filtering can also be performed according to date (e.g., limiting results displayed to those associated with content posted within a specified time). Additionally, the filtering can limit the presented search results to those associated with the user's social graph.

The system augments 310 the displayed search results. For example, if the user input filters the search results according to a particular friend, only search results associated with that friend are presented (e.g., photos, video, reviews, and comments made by that friend). Similarly, if the received user input limits the displayed search results to those associated with the user's social graph, the system augments the displayed search results to only include those results.

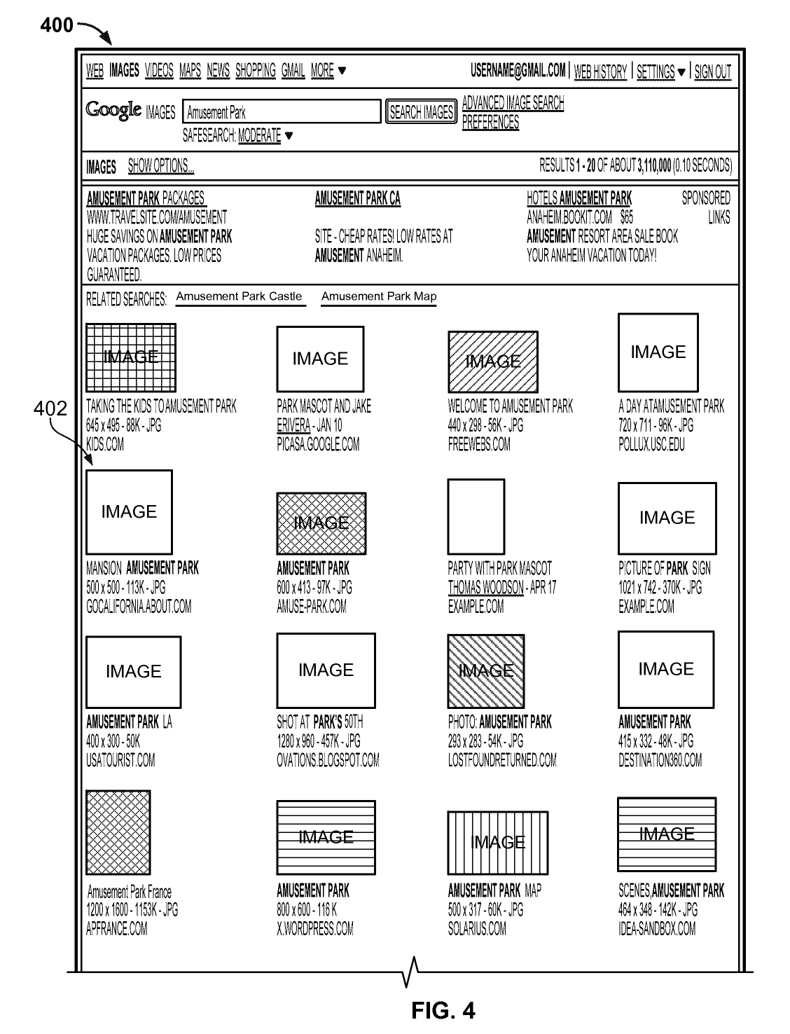

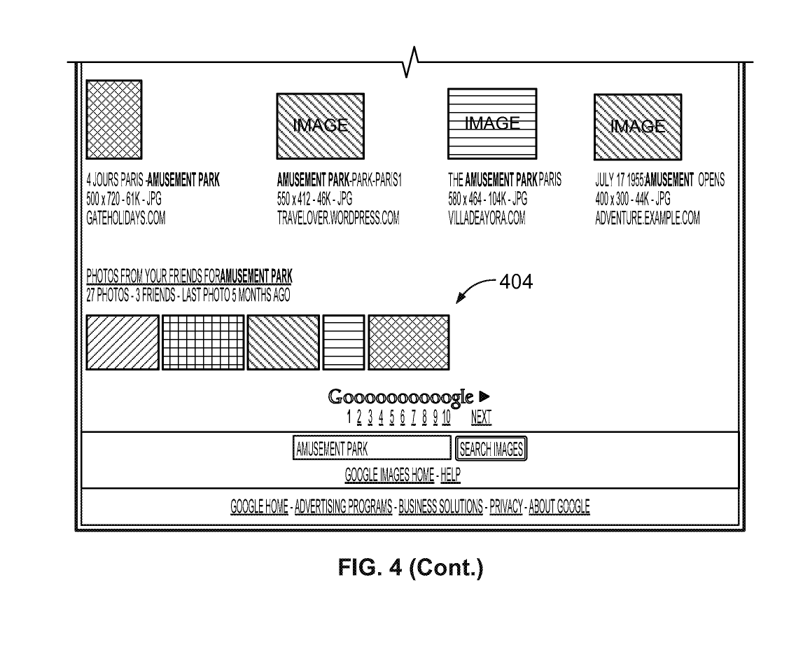

FIG. 4 is a representation of an example image search results page 400 including image results associated with the user's social graph. The search results page 400 includes a list of search results responsive to the query “amusement park”. Each image search results includes a thumbnail representing the resource identified by the image search result, an identification of the source of the search result (e.g., a particular domain), in addition to other metadata (e.g., the size and dimensions of the source image resource).

The displayed image search results includes web results 402, as well as results from friends 404 (e.g., members of the user's social graph). The results from friends 404 includes responsive image search results associated with a social graph of the user. Additionally, the results from friends 404 also identifies information about the available images including the number of images, the number of members of the user's social graph from which the images were identified, and the date of the most recent photo. For example, results from friends 404 identifies a total of 27 photos from three friends with the most recent being dated 5 months ago.

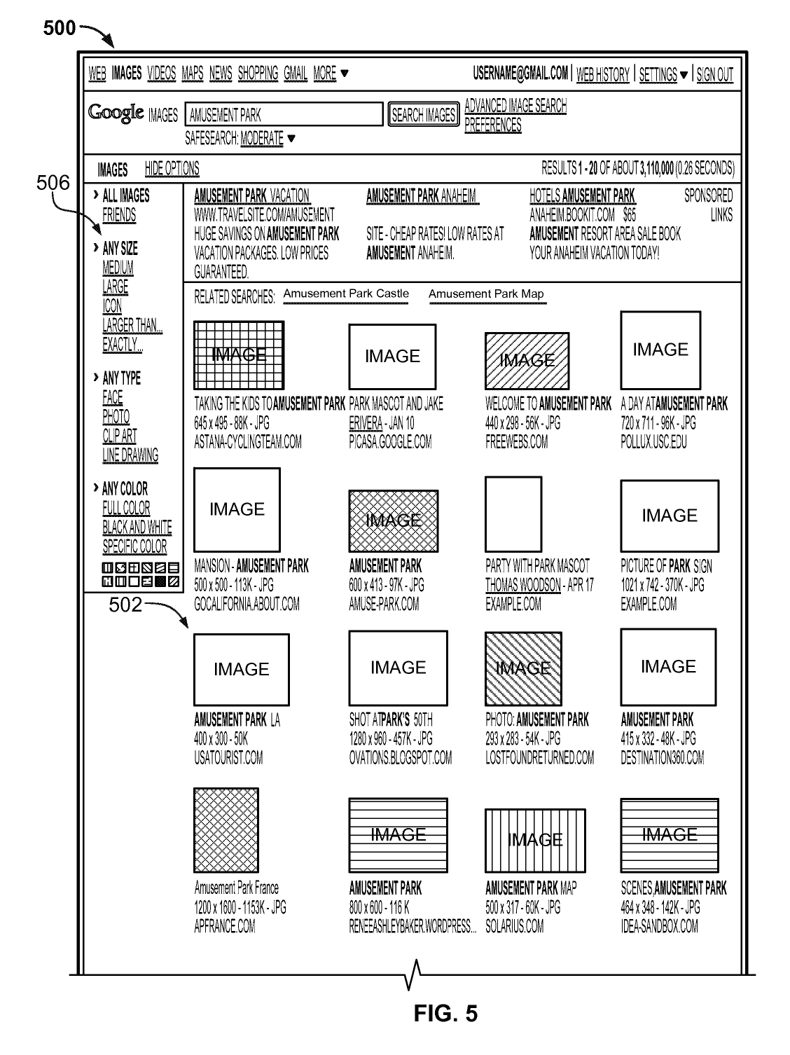

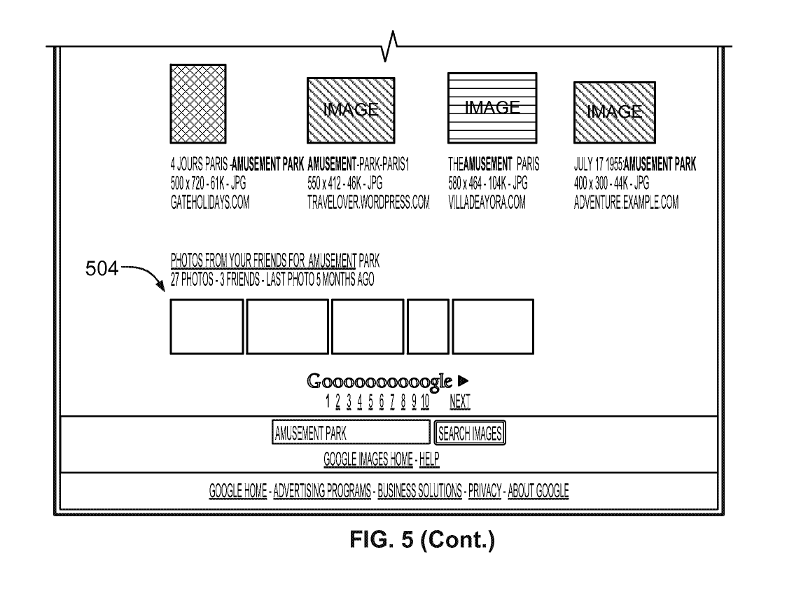

FIG. 5 is a representation of an example image search results page 500 showing image results associated with the user's social graph. The search results page 500 includes a list of image search results responsive to the query “amusement park”. Each image search results includes a thumbnail representing the resource identified by the image search result, an identification of the source of the search result (e.g., a particular domain), in addition to other metadata (e.g., the size and dimensions of the source image resource).

The displayed image search results includes web results 502, as well as results from friends 404. The results from friends 504 includes responsive image search results associated with a social graph of the user.

The image search results page 500 also includes an options sidebar 506. The options sidebar 506 includes options for the size of the image resources associated with the image search results, as well as the color and type of image resources. Additionally, the options sidebar 506 includes a friends option and an all images option. The all image option, shown selected, presents both general image search results and image search results associated with the user's social graph. The friends option, however, filters the image search results to display just those associated with the user's social graph.

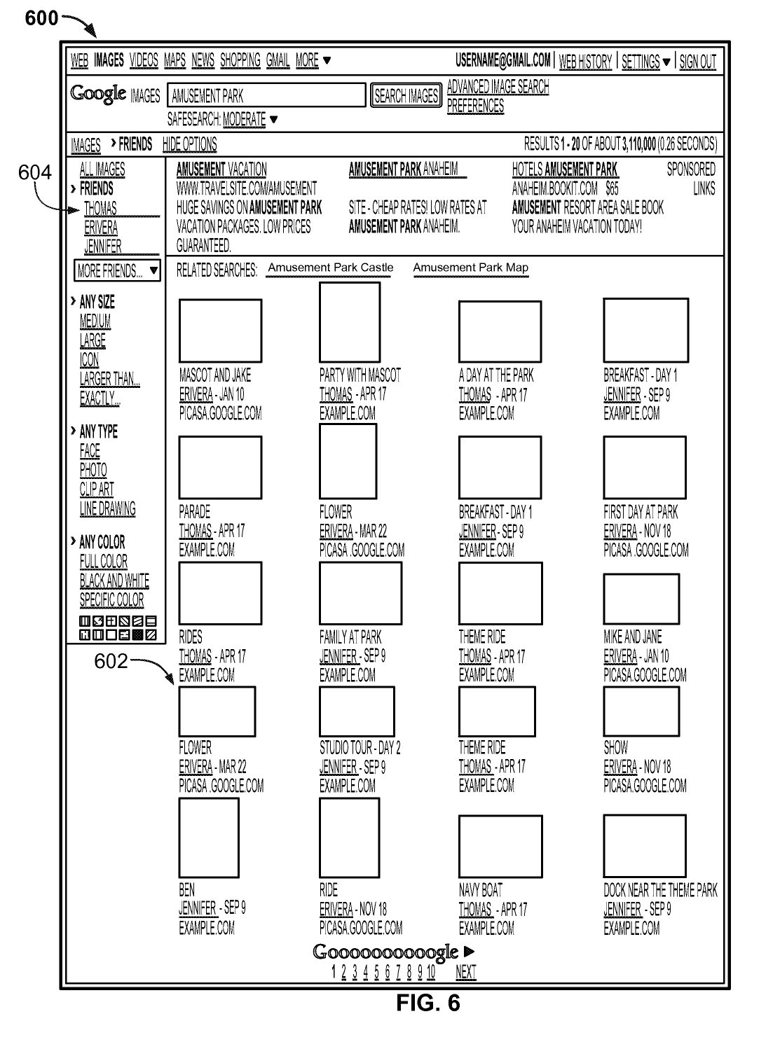

FIG. 6 is a representation of an example image search results page 600 showing image results associated with the user's social graph. The search results page 600 includes a list of image search results 602 responsive to the query “amusement park”. In particular, each of the displayed image search results is associated with the user's social graph (i.e., general image search results are not displayed). Each displayed search result of the image search results 602 identifies the name of the member of the user's social graph associated with the corresponding image resource. Additionally, in some implementations, the name of the member can be selected in order to filter the image search results according to the particular selected member.

Additionally, the “friends” option is selected in an options sidebar 604. The options sidebar 604 also displays one or more members of the user's social graph associated with the image search results. A drop down menu allows for the presentation of a larger list of members of the user's social graph.

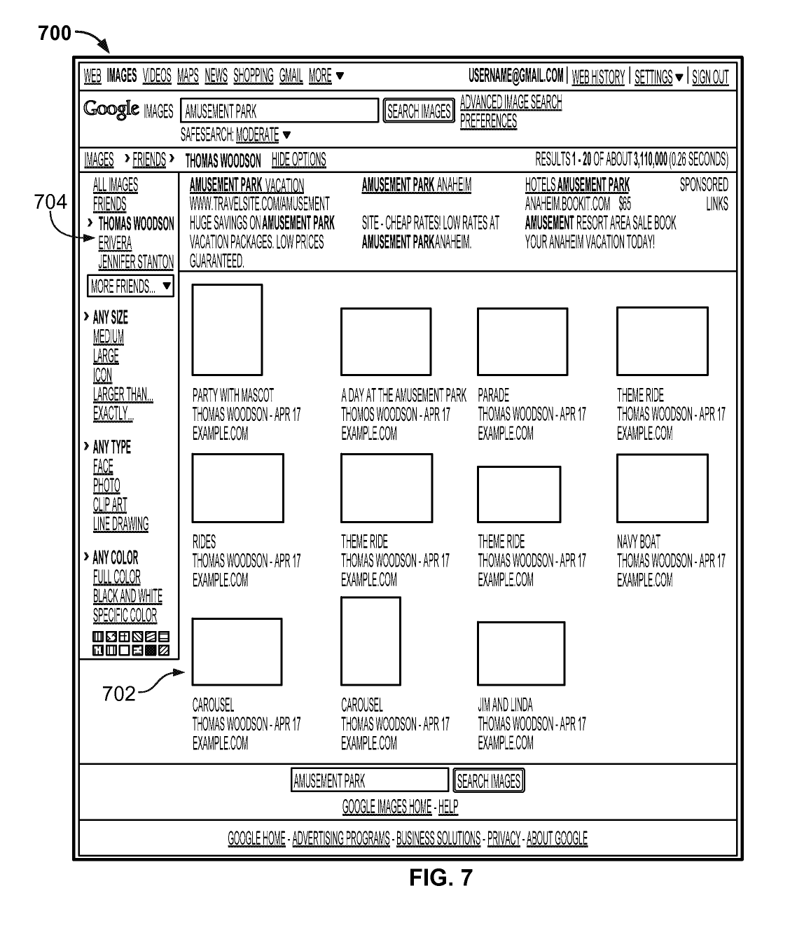

FIG. 7 is a representation of an example image search results page 700 showing image results associated with a selected member of a user's social graph. The search results page 700 includes a list of image search results 702 responsive to the query “amusement park”. In particular, each of the displayed image search results is associated with a particular selected member of the user's social graph. Additionally, an options sidebar 704 identifies the selected member of the user's social graph, as well as allows the user to select other members, the members as a whole, or all images.

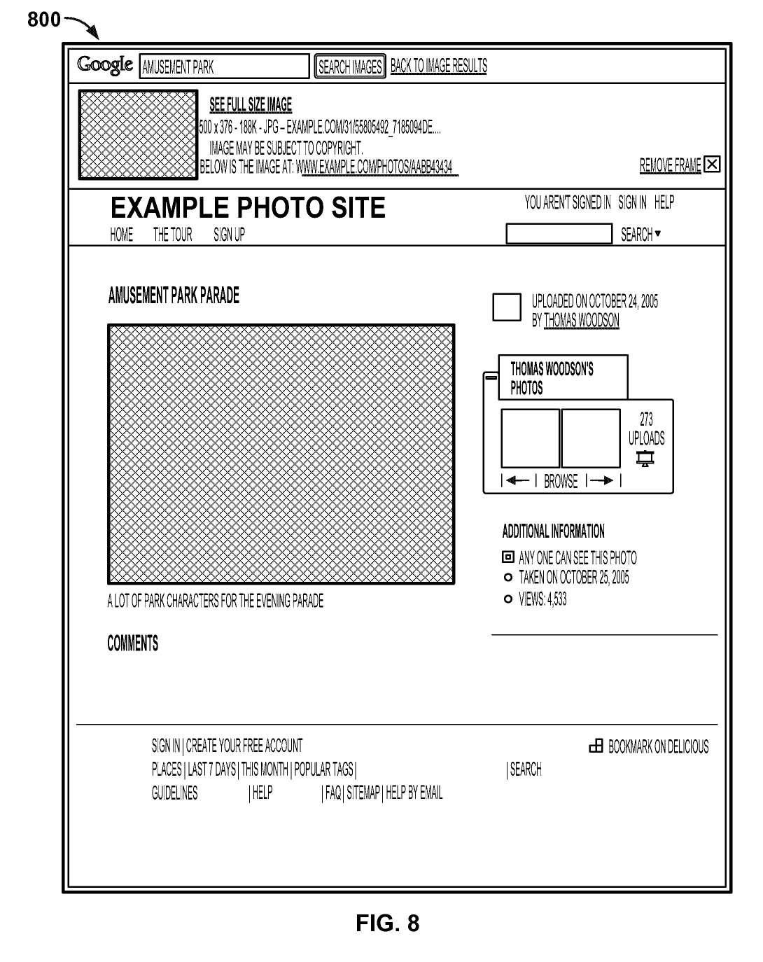

FIG. 8 is a representation of an example display 800 when a user selects a particular search result. In particular, when a user selects a search result, a frame is provided with the image search result along with the retrieved resource associated with the selected image search result (e.g., a web page including the image resource).

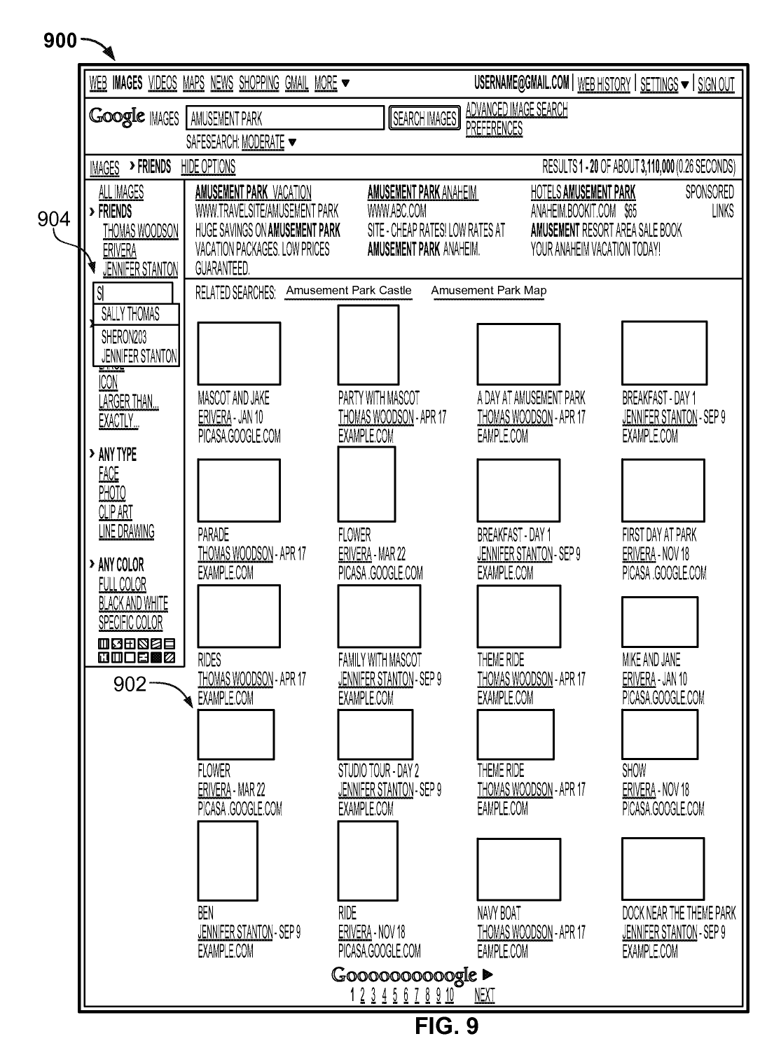

FIG. 9 is a representation of an example image search results page 900 showing image results associated with friends including a search friend filter. The search results page 900 includes a list of image search results 902 responsive to the received image search query.

In particular, each of the displayed image search results is associated with the user's social graph (i.e., general image search results are not displayed). Additionally, the “friends” option is selected in an options sidebar 904. The options sidebar 904 also displays one or more members of the user's social graph associated with the image search results. The options sidebar 904 also includes a search box filter that allows the user to input a particular member of the user's social graph. In some implementations, members of the user's social graph are predicted as input is entered, for example, entering “s” results in a pop-up list of members of the user's social graph that have a word (e.g., first name, last name) beginning with “s”.

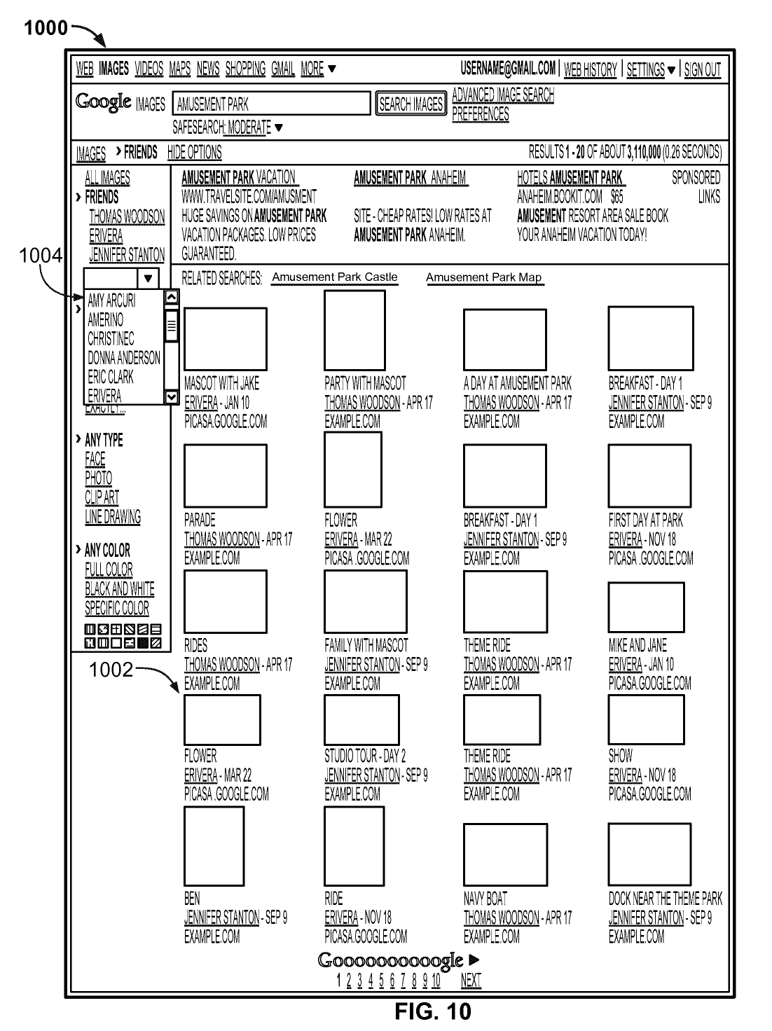

FIG. 10 is a representation of an example image search results page 1000 showing image results associated with friends including a browse friend filter. The search results page 1000 includes a list of image search results 1002 responsive to the received image search query.

In particular, each of the displayed image search results is associated with the user's social graph (i.e., not general image search results are displayed). Additionally, the “friends” option is selected in an options sidebar 1004. The options sidebar 1004 also displays one or more members of the user's social graph associated with the image search results. The options sidebar 1004 also includes a drop down box that lists the members of the user's social graph associated with the image search results.

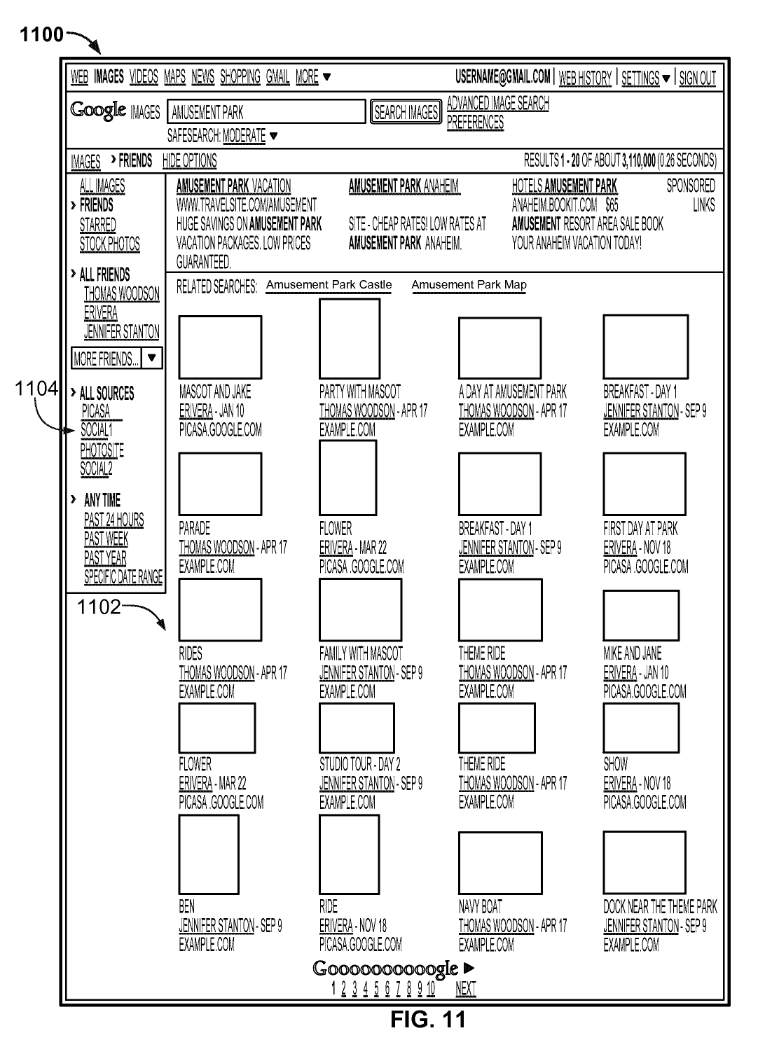

FIG. 11 is a representation of an example image search results page 1100 showing image results associated with friends including source filtering. The search results page 1100 includes a list of image search results 1102 responsive to the receives image search query.

In particular, each of the displayed image search results is associated with the user's social graph (i.e., not general image search results are displayed). Additionally, the “friends” option is selected in an options sidebar 1104. The options sidebar 1104 also displays source filtering options. The source filtering options allow the user to filter the image search results based on the source of the associated resources (e.g., what web site, social site, blog, or image hosting service the images are from). When selected, the image search results are augmented to display only those image search results satisfying the selection.

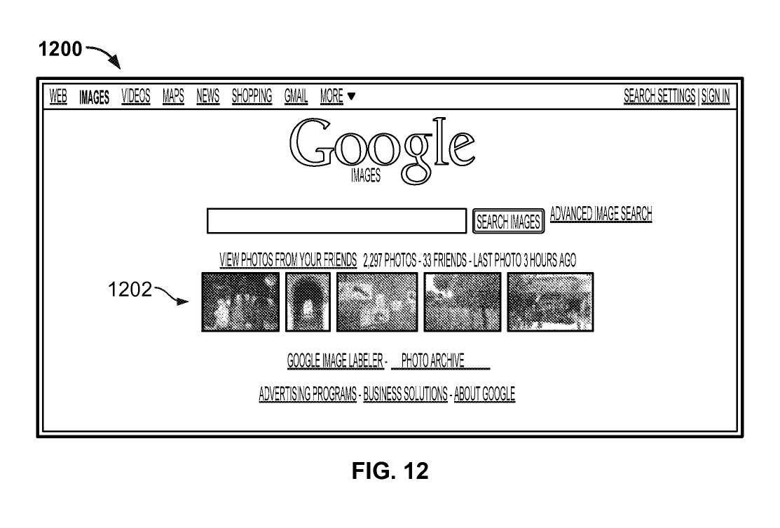

FIG. 12 is a representation of an example image search interface 1200 including image results associated with the user's social graph. The image search interface 1200 includes a search field for receiving an image search query from a user. The user can then execute the search by selecting a “search images” button. The image search interface 1200 also includes images 1202 associated with the user's social graph. The images 1202 are not associated with any particular search, since a search has not been performed. Instead, the images 1202 can represent a random selection of available image resources associated with members of the user's social graph.

Additional data about the available image resources can be presented including the total number of images from a number of members of the user's social graph associated with the images. In particular, as shown in the image search interface 1200, the user's social graph has 2,297 images from 33 members where the last photo was added 3 hours ago.

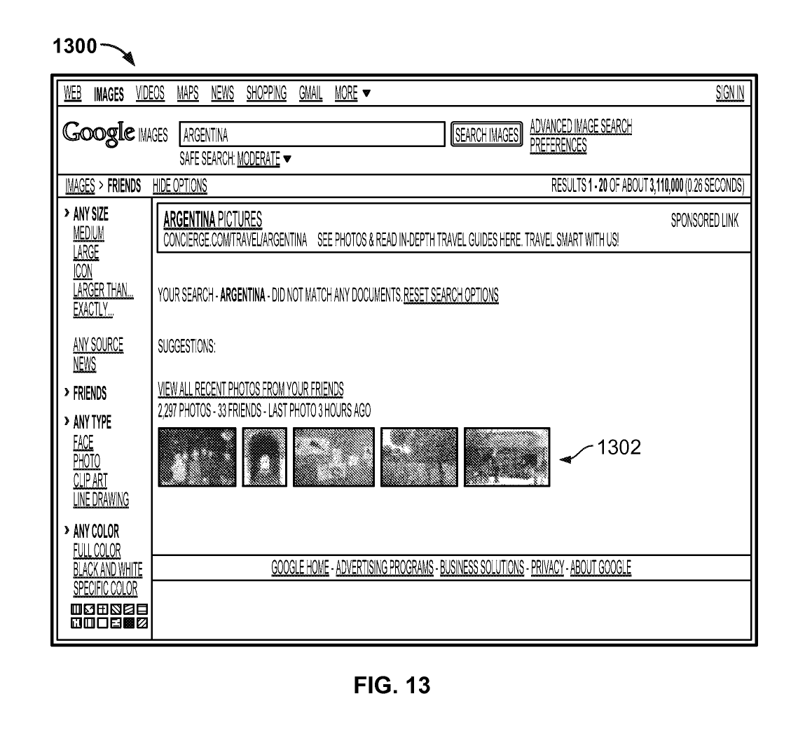

FIG. 13 is a representation of an example null image search results page 1300 including images results associated with the user's social graph. The null image search results page 1300 represents a page displayed when the user's image search query did not result in any image search results responsive to the query. In particular, the user is searching for images in the user's social graph, not a general corpus (e.g., not over the entire Web). The user's image search query of “argentina” did not result in any image results associated with the user's social graph (e.g., images belonging to individual members of the user's social graph). However, the null image search results page 1300 also includes images 1302. The images 1302 represent recent images associated with the user's social graph. Thus, the user can browse newly added photos by members of their social graph. Additional data about the available image resources can be presented, including the total number of photos and from a particular number of members of the user's social graph.

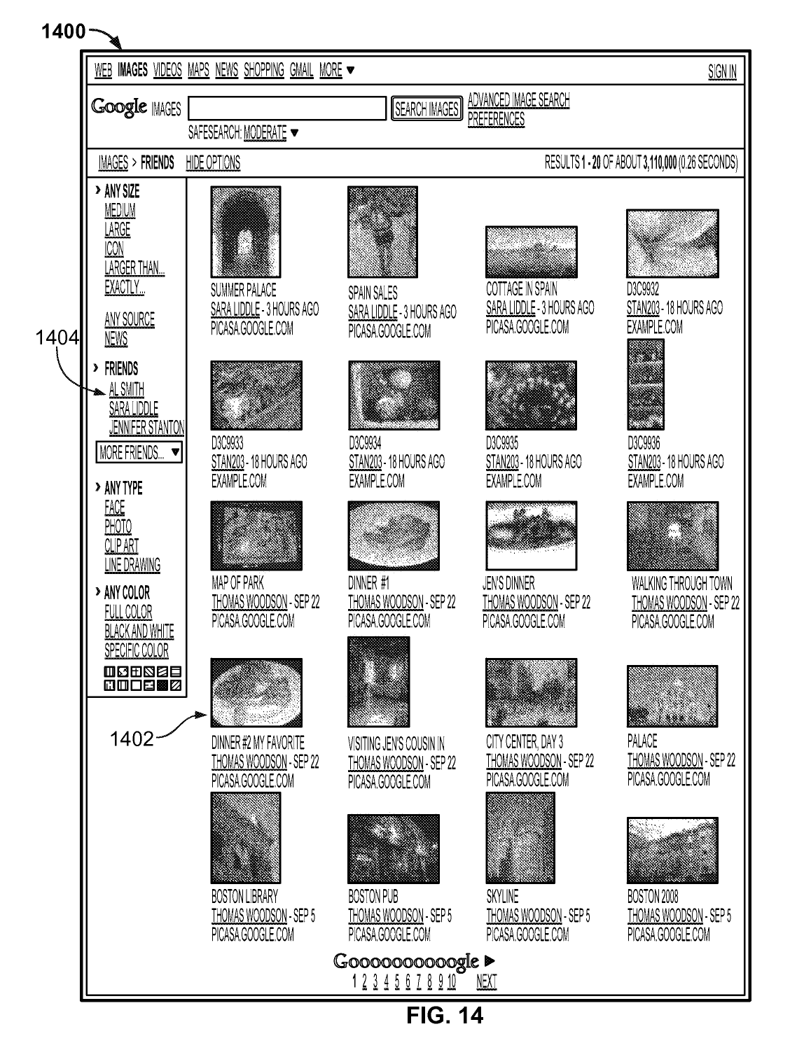

FIG. 14 is a representation of an example image search interface 1400 including image results associated with the user's social graph. The image search interface 1400 includes search field for receiving an image search query from a user. The user can then execute the search by selecting a “search images” button. The image search interface 1400 also includes images 1402 associated with the user's social graph. The images 1402 are not associated with any particular search, since a search has not been performed. Instead, the images 1402 can represent a random selection of available image resources associated with members of the user's social graph. Each image 1402 also identifies the member of the user's social graph associated with the corresponding image resource. Additionally, an options sidebar 1404 allows the user to filter the displayed image results by members of the user's social graph.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A method comprising:
receiving an image search query from a user, the image search query including one or more terms;
identifying image search results responsive to the image search query including general image search results responsive to the image search query and social image search results responsive to the image search query, wherein each of one or more of the social image search results is associated with an image published by a respective member of a plurality of members of a social graph of the user;
ordering the image search results including the general image search results and social image search results in a single ranking order according to one or more ranking factors, wherein the positioning of a first plurality of the social image search results among the ordering of the image search results is based at least on a measure of respective affinity between the user and the respective member of the social graph of the user that published content associated with each of the first plurality of the social image search results, wherein the measure of affinity between the user and each member of the social graph indicates a closeness of each member to the user based on how the user is connected to the respective member in the social graph and interactions between the user and the respective member;
clustering the ordered first plurality of social image search results according to the respective members of the social graph of the user that published the images associated with the ordered first plurality of social image search results;
providing a plurality of the ordered image search results responsive to the image search query to the user including one or more of the clustered social image search results published by respective members of the social graph of the user, where the image search results are provided according to the single ranking order of the image search results;
after providing the plurality of the ordered image search results to the user, receiving user input specifying a filter to apply to the provided plurality of ordered image search results;
according to the specified filter, removing all provided ordered image search results except those associated with a selected member of the plurality of members of the social graph of the user; and
wherein receiving, identifying and providing are performed by data processing apparatus.

2. The method of claim 1 wherein providing the plurality of ordered image search results comprises providing the social image search results interleaved with one or more of the general image search results.

3. The method of claim 1 wherein providing the plurality of ordered image search results comprises separately providing the social image search results from the general identified search results.

4-5. (canceled)

6. The method of claim 1 wherein filtering the provided ordered image search results includes removing all image search results other than the image search results associated with a selected image source.

7. The method of claim 1, further comprising determining the members of the social graph of the user based on connections to the user according to a degree of separation.

8. The method of claim 1 wherein identifying the social image search results comprises searching an index of information for the social graph of the user to identify social image search results associated with members of the user's social graph.

9. A system comprising:
data processing apparatus programmed to perform operations comprising:
receiving an image search query from a user, the image search query including one or more terms;
identifying image search results responsive to the image search query including general image search results responsive to the image search query and social image search results responsive to the image search query, wherein each one or more of the social image search results is associated with an image published by a respective member of a plurality of members of a social graph of the user;
ordering the image search results including the general image search results and social image search results in a single ranking order according to one or more ranking factors, wherein the positioning of a first plurality of the social image search results among the ordering of the image search results is based at least on a measure of respective affinity between the user and the respective member of the social graph of the user that published content associated with each of the first plurality of the social image search results, wherein the measure of affinity between the user and each member of the social graph indicates a closeness of each member to the user based on how the user is connected to the respective member in the social graph and interactions between the user and the respective member;
clustering the ordered first plurality of social image search results according to the respective members of the social graph of the user that published the images associated with the ordered first plurality of social image search results;
providing a plurality of the ordered image search results responsive to the image search query to the user including one or more of the clustered social image search results published by respective members of the social graph of the user, where the image search results are provided according to the single ranking order of the image search results;
after providing the plurality of the ordered image search results to the user, receiving user input specifying a filter to apply to the provided plurality of ordered image search results; and
according to the specified filter, removing all provided ordered image search results except those associated with a selected member of the plurality of members of the social graph of the user.

10. The system of claim 9 wherein providing the plurality of ordered image search results comprises providing the social image search results interleaved with one or more of the general image search results.

11. The system of claim 9 wherein providing the plurality of ordered image search results to the user comprises separately providing the social image search results from the general identified search results.

12-13. (canceled)

14. The system of claim 9 wherein filtering the provided ordered image search results includes removing all image search results other than the image search results associated with a selected image source.

15. The system of claim 9, further comprising determining the members of the social graph of the user based on connections to the user according to a degree of separation.

16. The system of claim 9 wherein identifying the social image search results comprises searching an index of information for the social graph of the user to identify social image search results associated with members of the user's social graph.

17. A machine-readable storage device having instructions stored thereon that, when executed by data processing apparatus, cause the data processing apparatus to perform operations comprising:
receiving an image search query from a user, the image search query including one or more terms;
identifying image search results responsive to the image search query including general image search results responsive to the image search query and social image search results responsive to the image search query, wherein each of one or more of the social image search results is associated with an image published by a respective member of a plurality of members of a social graph of the user;
ordering the image search results including the general image search results and social image search results in a single ranking order according to one or more ranking factors, wherein the positioning of a first plurality of the social image search results among the ordering of the image search results is based at least on a measure of respective affinity between the user and the respective member of the social graph of the user that published content associated with each of the first plurality of the social image search results, wherein the measure of affinity between the user and each member of the social graph indicates a closeness of each member to the user based on how the user is connected to the respective member in the social graph and interactions between the user and the respective member;
clustering the ordered first plurality of social image search results according to the respective members of the social graph of the user that published the images associated with the ordered first plurality of social image search results;
providing a plurality of the ordered image search results responsive to the image search query to the user including one or more of the clustered image social search results published by respective members of the social graph of the user, where the image search results are provided according to the single ranking order of the image search results;
after providing the plurality of the ordered image search results to the user, receiving user input specifying a filter to apply to the provided plurality of ordered image search results; and
according to the specified filter, removing all provided ordered image search results except those associated with a selected member of the plurality of members of the social graph of the user.

18. The storage device of claim 17 wherein providing the plurality of ordered image search results comprises providing the social image search results interleaved with one or more of the general image search results.

19. The storage device of claim 17 wherein providing the plurality of ordered image search results comprises separately providing social image search results from general identified search results.

20-21. (canceled)

22. The storage device of claim 17 wherein filtering the provided ordered image search results includes removing all image search results other than the image search results associated with a selected image source.

23. The storage device of claim 17, further comprising determining the members of the social graph of the user based on connections to the user according to a degree of separation.

24. The storage device of claim 17 wherein identifying the one or more image search results associated with the social graph of the user comprises searching an index of information for the social graph of the user to identify social image search results associated with members of the user's social graph.
